(19) United States
(12) Patent Application Publication
(10) Pub. No.: US 2019/0147351 A1
(43) Pub. Date: May 16, 2019

(54) METHOD AND SYSTEM FOR AUTOMATICALLY BUILDING INTELLIGENT ASSISTANT

(71) Applicant: INSTITUTE FOR INFORMATION INDUSTRY, Taipei (TW)

(72) Inventors: Rong-Sheng WANG, Taipei City (TW); Shih-Chun CHOU, Taipei City (TW); Hong-En CHEN, Tainan City (TW); Hsiao-Chen CHANG, Taipei City (TW); Shun-Ju LI, Taipei City (TW)

(21) Appl. No.: 15/829,974

(22) Filed: Dec. 3, 2017

(30) Foreign Application Priority Data
Nov. 14, 2017 (TW) 106139350

(51) Int. Cl. G06N 5/02

(52) U.S. Cl. CPC G06N 5/022

(57) ABSTRACT

A method and system for automatically building intelligent assistant is disclosed herein. The method includes the following operations: acquiring an intelligent assistant template; acquiring a plurality of application programming interfaces and a plurality of application programming interface files; identifying a plurality of first entities of the plurality of application programming interface files; comparing the plurality of first entity to generate a similarity value for each of a plurality of operation functions; determining the plurality of application programming interface files and the plurality of application programming interfaces corresponding thereto, respectively corresponding to each of the plurality of operation functions, according to the similarity value for the plurality of first entity; and generating an intelligent assistant according to the determined plurality of operation functions corresponding to the plurality of application programming interfaces.

### RELATED APPLICATIONS

This application claims priority to Taiwan Application Serial Number 106139350, filed Nov. 14, 2017, the entirety of which is herein incorporated by reference.

### BACKGROUND

### Technical Field

The disclosure relates to a method and system for building an intelligent assistant, and particularly to a method and system for automatically building an intelligent assistant having the ability of identifying semantic.

### Description of Related Art

As lives of modern people become more and more busy, customers have increasingly demands for faster and more convenient services provided by enterprises. Furthermore, along with emergence of smart personal assistants such as Siri available from Apple Inc, Bixby available from Samsung Corp, Cortana available from Microsoft Corporation and the like, customers increasingly get used to make something in their daily lives be accomplished by the smart personal assistant, and enterprises also utilize the smart personal assistant as a bridge for communicating with customers in order to provide a more humanized and more convenient service interface. Therefore, it is an important issue for the enterprise how to build an intelligent assistant in an easy and fast manner.

### SUMMARY

The main object of the disclosure is to provide a method and system for automatically building an intelligent assistant, which is mainly capable of quickly building an intelligent assistant by using application programming interfaces and application programming interface files already built by an enterprise so as to help the enterprise with providing services to customers in a more convenient and more humanized manner.

For purpose of achieving the aforementioned object, a first aspect of the disclosure provides a method for automatically building an intelligent assistant, which includes the following steps: acquiring an intelligent assistant template by a processor from a storage device, wherein the intelligent assistant template has a plurality of operation functions for accomplishing the service; acquiring a plurality of application programming interfaces and a plurality of application programming interface files corresponding thereto by the processor; identifying a plurality of first entities of the plurality of application programming interface files by the processor; comparing the plurality of first entities of the plurality of application programming interface files by the processor to generate a similarity value for each of a plurality of operation functions; determining the plurality of application programming interface files and the plurality of application programming interfaces corresponding thereto, respectively corresponding to each of the plurality of operation functions, according to the similarity value for the plurality of first entities; and generating a intelligent assistant according to the determined plurality of application programming interfaces corresponding to the plurality of operation functions by the processor.

The second aspect of the disclosure is providing a system for automatically building an intelligent assistant, which includes: a processor and a storage device. The storage device is electrically connected to the processor and stores an intelligent assistant template, wherein the intelligent assistant template includes a plurality of operation functions for accomplishing a service; wherein the processor includes an interpretation module for acquiring application programming interfaces and application programming interface files corresponding thereto and identifying first entities of the application programming interface files; a similarity value calculation module for comparing the plurality of first entities to generate a similarity value respectively for each of the plurality of operation functions; a service type generation module for determining one of the plurality of application programming interface files and the plurality of application programming interfaces corresponding thereto, respectively corresponding to each of the plurality of operation functions, according to the similarity value for the plurality of first entities of the plurality of application programming interface files; and an intelligent assistant building module for generating a intelligent assistant according to the determined plurality of application programming interfaces corresponding to the plurality of operation functions.

The method and system for automatically building an intelligent assistant of the disclosure, is mainly capable of quickly building an intelligent assistant, helping the enterprise with providing services to customers in a more convenient and more humanized manner, improving the problem that the consumers have to be familiar with different interfaces provided by different enterprises, thereby achieving the effect of effectively reducing the labor cost and improving the service efficiency.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a functional block diagram illustrating a system for automatically building an intelligent assistant according to an embodiment of the disclosure;

FIG. 2 is a flow diagram illustrating a method for automatically building an intelligent assistant according to an embodiment of the disclosure;

FIG. 3 is a schematic diagram illustrating an application programming interface file according to an embodiment of the disclosure;

FIG. 4 is a flow diagram illustrating a step S240 according to an embodiment of the disclosure; and

FIG. 5 is a schematic diagram illustrating an interaction between a user and an intelligent assistant according to an embodiment of the disclosure.

### DETAILED DESCRIPTION

The disclosure below provides many different embodiments or examples of implementing varying features in the present invention. In the discussion below, elements and configurations in special examples are used for simplifying the disclosure. Any discussed example may be used for illustration only, and will not limit the present invention or scopes and meanings of examples thereof by any way. In addition, the disclosure may repeat identical numeric symbols and/or letters in different examples only for the purpose of simplification and explanation. The repetition itself does not designate the relation between different embodiments and/or arrangements in the discussion below.

Otherwise specially noted, each of terms used through the specification and claims generally has its regular meaning as used in this art, the content in this disclosure, and special content. Certain terms used to describe this disclosure will be discussed below, or elsewhere in this specification, to provide persons skilled in this art with additional guidance on the description about this disclosure.

“Couple” or “connect” used herein may both refer to two and more elements being in direct or indirect contact with each other physically or electrically. “Couple” or “connect” may also refer to two or more elements being operating or acting on each other.

It is understandable to use the first, second, third, or other terms herein for the purpose of describing various elements, components, regions, layers and/or blocks. However, these elements, components, regions, layers and/or blocks should not be limited by the terms aforesaid. These terms may be used to distinguish a single element, component, region, layer and/or block only. Therefore, a first element, component, region, layer and/or block below may also be referred to as a second element, component, region, layer and/or block without departing from the present invention's intention. As used herein, the term “and/or” includes any combinations of one or more of listed relevant items. “And/or” mentioned in the present invention refers to any combinations of any, all, or at least one elements listed in the table.

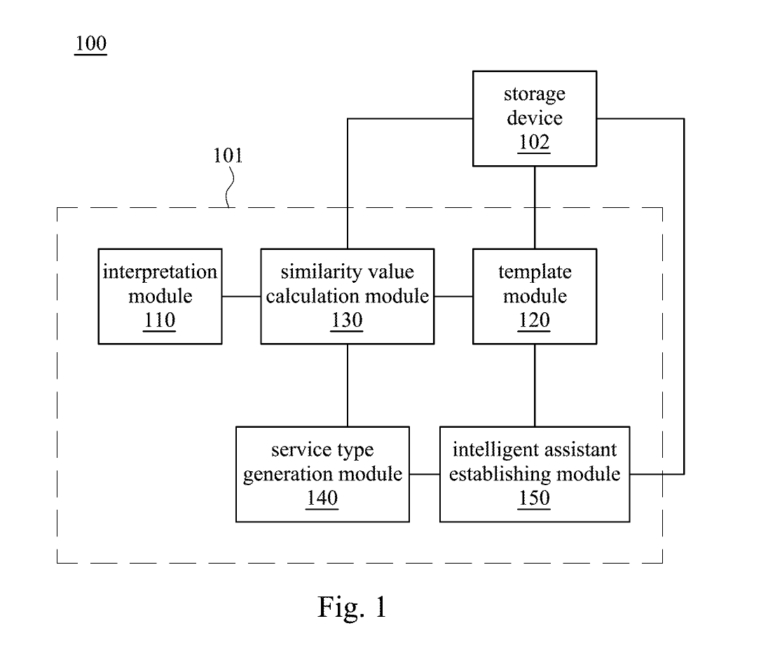

Reference is made to FIG. 1, which is a functional block diagram illustrating a system 100 for automatically building an intelligent assistant according to an embodiment of the disclosure. As shown in FIG. 1, the system 100 for automatically building the intelligent assistant includes a processor 101 and a storage device 102, wherein the storage device 102 is electrically connected to the processor 101 and stores an intelligent assistant template, the intelligent assistant template including a plurality of operation functions for accomplishing a service. The processor 101 includes an interpretation module 110, a template module 120, a similarity value calculation module 130, a service type generation module 140 and an intelligent assistant building module 150. The interpretation module 110 is configured for acquiring a plurality of application programming interfaces and a plurality of application programming interface files corresponding thereto, and identifying a plurality of first entities of the plurality of application programming interface files. The similarity value calculation module 130 is configured for comparing the plurality of first entities of the application programming interface files to generate a similarity value for each of a plurality of operation functions. The service type generation module 140 is configured for determining one of the plurality of application programming interface files and the plurality of application programming interfaces corresponding thereto, respectively corresponding to each of the plurality of operation functions, according to the similarity value for the plurality of first entities of the plurality of application programming interface files. The intelligent assistant building module 150 is configured for generating a corresponding intelligent assistant according to the determined plurality of application programming interfaces corresponding to the plurality of operation function.

In some embodiments, the storage device 102 can include a portable computer-readable recording medium, such as a memory, a hard disk, a flash disk, a memory card and the like. In some embodiments, computer programs and data can be stored on the portable computer readable recording medium, and can be loaded onto the storage device 102 through an I/O interface. The I/O interface may also be connected to a display. The processor 101 can be implemented as an integrated circuit, such as a micro-controller, a microprocessor, a digital signal processor, an application specific integrated circuit (ASIC), a logic circuit or other similar elements, or a combination thereof.

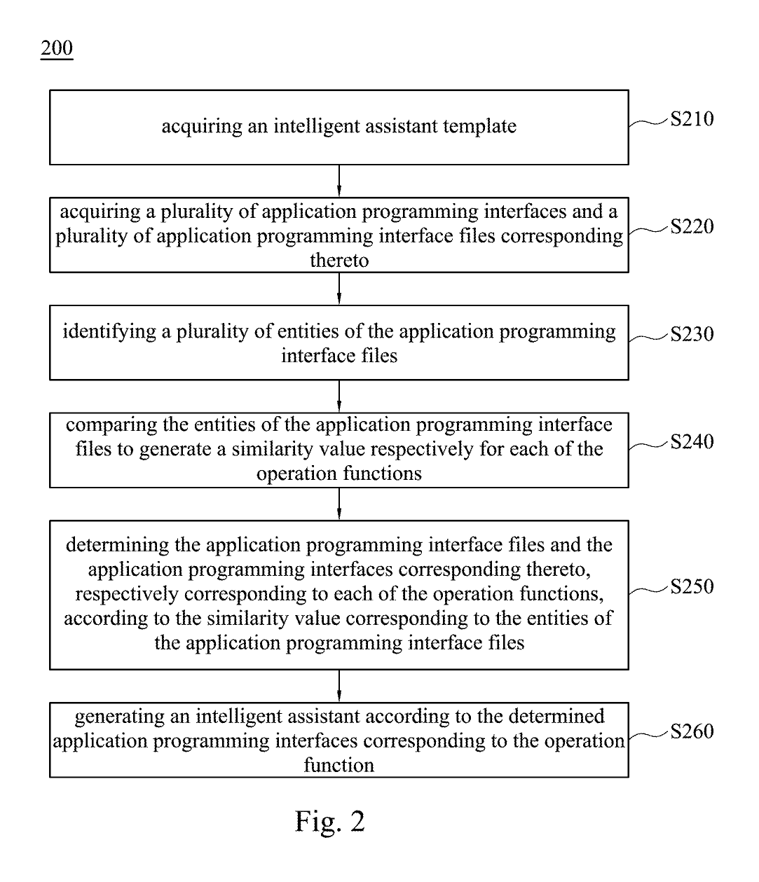

Reference is made to FIG. 2, which is a flow diagram illustrating a method 200 for automatically building an intelligent assistant according to an embodiment of the disclosure. The method 200 for automatically building an intelligent assistant according to a first embodiment of the disclosure analyzes application programming interface (API) files of an enterprise, then screening application programming interface files in need by comparison utilizing a similarity calculation manner and building a service. As shown in FIG. 2, the method 200 for automatically building an intelligent assistant includes the following steps:

Step S210: acquiring an intelligent assistant template;

Step S220: acquiring a plurality of application programming interfaces and a plurality of application programming interface files corresponding thereto;

Step S230: identifying a plurality of entities of the application programming interface files;

Step S240: comparing the entities of the application programming interface files to generate a similarity value respectively for each of the operation functions;

Step S250: determining the application programming interface files and the application programming interfaces corresponding thereto, respectively corresponding to each of the operation functions, according to the similarity value for the entities of the application programming interface files; and

Step S260: generating an intelligent assistant according to the determined application programming interfaces corresponding to the operation function.

In order to make the method 200 for automatically building the intelligent assistant according to the first embodiment of the disclosure be easy to understand, please make reference to FIGS. 1 to 5.

In step S210, an intelligent assistant template is acquired, which has a plurality of operation functions for accomplishing a service. With respect to the intelligent assistant template, for example, if it is able to build an intelligent assistant for assisting airline-ticket booking, the intelligent assistant template may need to have a function of checking a flight schedule, a function of selecting a departure site and a destination site, a function of selecting a departure time and an arrival time, and a function of checking remaining empty seats. Furthermore, the operation functions of the intelligent assistant template are a variety of functions required for sequentially accomplishing a ticket booking service, and the aforementioned functions are performed by an application service interface. The aforementioned functions are preset in the intelligent assistant template so as to conduct the subsequent operations. The intelligent assistant template can be built and stored in advance by a program developer, and can also be generated automatically through the template module 120 from the intelligent assistant and the intelligent assistant template used for a similar service.

In step S220, a plurality of application programming interfaces and a plurality of application programming interface files corresponding thereto are acquired. The application programming interfaces and application programming interface files corresponding thereto of an enterprise are collected. As a continue to the aforementioned embodiment, if it is wanted to build an intelligent assistant for assisting airline-ticket booking, the application programming interfaces and application programming interface files corresponding thereto of various airline companies can be collected, and of course application programming interfaces and application programming interface files corresponding thereto of enterprises providing similar services (e.g., enterprises providing services such as train-ticket booking, high-speed-rail ticket booking and bus-ticket booking) can also be collected.

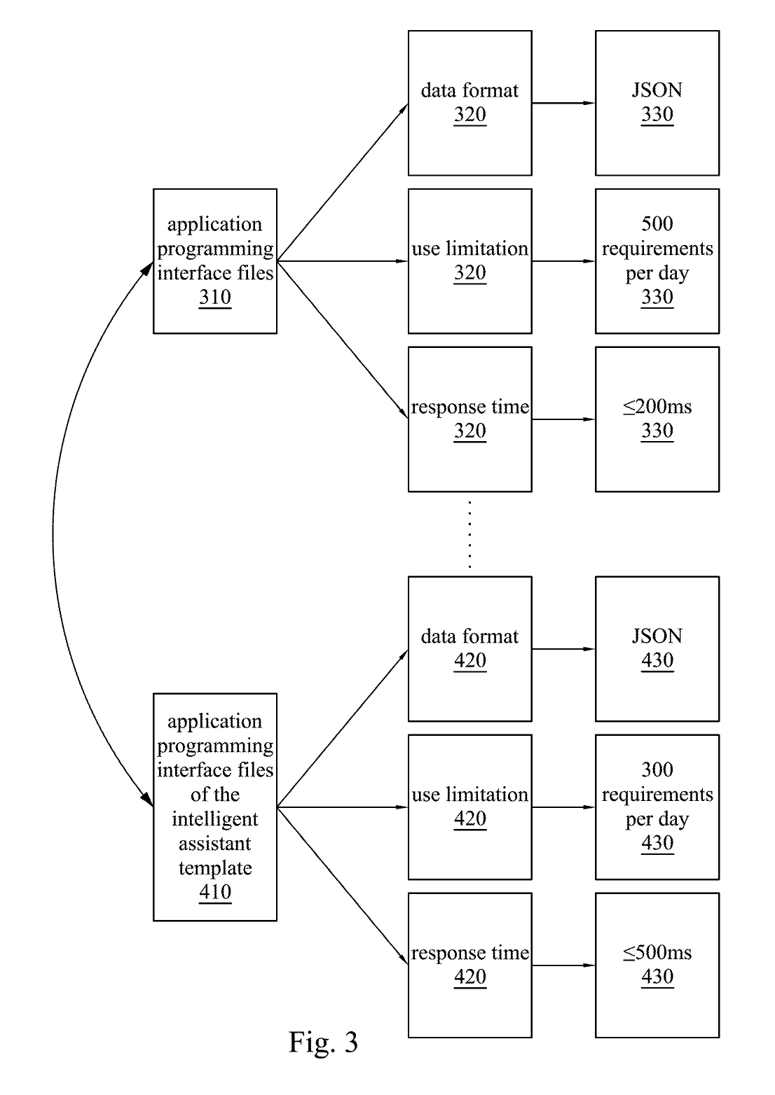

In step S230, a plurality of entities of the application programming interface files are identified. Reference is made to FIG. 3, which is a schematic diagram illustrating an application programming interface file according to an embodiment of the disclosure. As shown in FIG. 3, after the application programming interface files 310 are collected, it is necessary to perform an analysis on the entities 320 of the application programming interface files, wherein the entities 320 has a data format, a use limitation, a response time and the like, different entities 320 correspond to different entity contents 330, and the subsequent operations are continued after the entity contents 330 are identified.

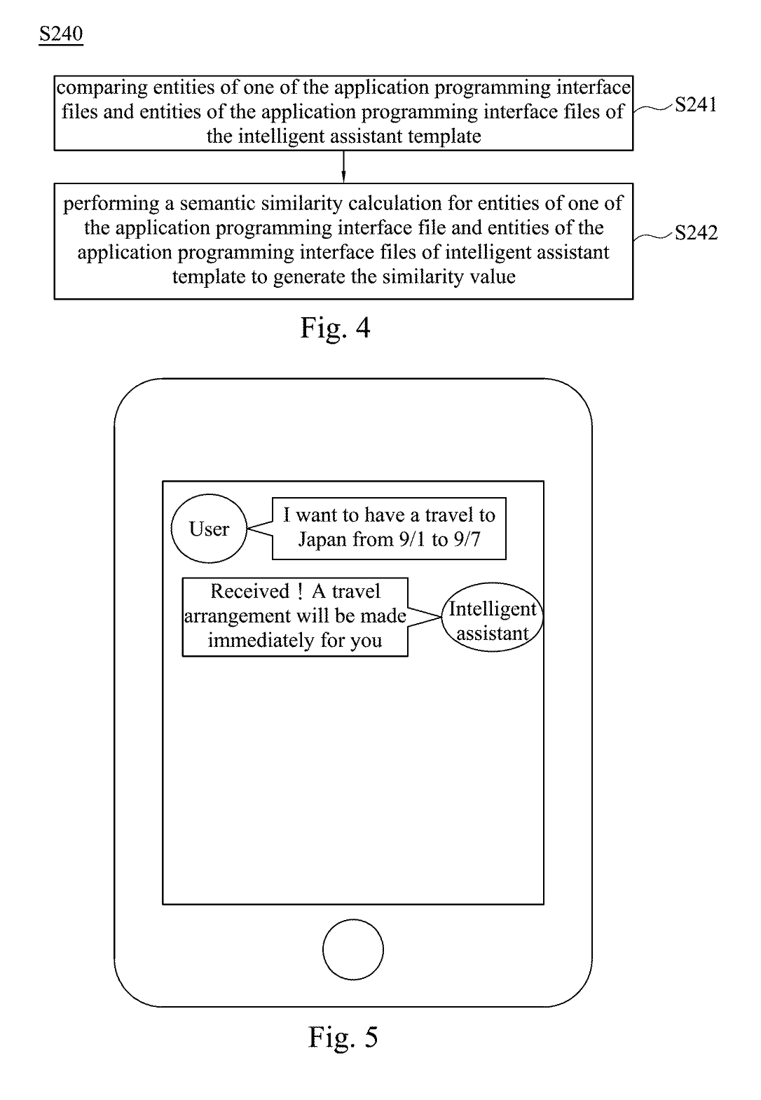

In step S240, the entities of the application programming interface files are compared to generate a similarity value respectively for each of the operation functions of the intelligent assistant template. For example, in the aforementioned embodiment where the intelligent assistant is configured for assisting airline-ticket booking, the operation functions are the function of checking a flight schedule, the function of selecting a departure site and a destination site, the function of selecting a departure time and an arrival time, and the function of checking remaining empty seats, each of the functions corresponding to at least one application programming interface and application programming interface files corresponding thereto. Reference is made to FIG. 4, which is a flow diagram illustrating a step S240 according to an embodiment of the disclosure. As shown in FIG. 4, step S240 includes the following steps:

Step S241: comparing entities of one of the application programming interface files and entities of the application programming interface files of the intelligent assistant template; and

Step S242: performing a semantic similarity calculation for entities of one of the application programming interface file and entities of the application programming interface files of intelligent assistant template to generate the similarity value.

Reference is also made to FIG. 3 and FIG. 4, all of the application programming interface files 310 are compared with the application programming interface files 410 of the intelligent assistant template; entities 320 and 420 are compared one by one by using a semantic similarity analysis, and then the similarity value for each of the application programming interface files 310 are calculated after the comparison application programming interface. The semantic similarity analysis can determine that the two application programming interface files are the same if they are words of similar meanings. Therefore, after the calculation of steps S241 and S242, the similarity value for each of the application programming interface files 310 can be obtained through calculation.

In step S250, the application programming interface files and the application programming interfaces corresponding thereto, respectively corresponding to each of the plurality of operation functions, are determined according to the similarity value for the entities of the application programming interface files. After the similarity value for each of the application programming interface files 310 is obtained through calculation, the application programming interface file having the largest similarity value is selected. That is, application programming interface files and application programming interfaces corresponding thereto, which are similar to the operation functions set by the intelligent assistant template, are found.

In the step S260, an intelligent assistant is generated according to the application programming interfaces corresponding to the operation function. For example, in the aforementioned embodiment where the intelligent assistant is used for assisting airline-ticket booking, firstly application programming interface files can be collected from a website of an airline company, then the collected application programming interface files are compared with the preset template for ticket booking, to find out the application programming interface files in associated with the ticket booking from the collected application programming interface files, and then the intelligent assistant having the function of ticket booking can be built.

In an embodiment, the intelligent assistant is configured for providing an operation interface, for inputting natural language data by a user, acquiring the inputting data required by the application program interfaces in the intelligent assistant from the natural language data after an intention analysis is performed, and transferring the application program interfaces in the intelligent assistant and the inputting data required by them to the website to request for performance. For example, in the aforementioned embodiment where the intelligent assistant is configured for assisting airline-ticket booking, the built intelligent assistant having the ticket booking function can be performed by the processor, and then the intelligent assistant communicates with the user through an operation interface. It can also install the built intelligent assistant having the ticket booking function onto the third-party communication software, such that the user can communicate with the intelligent assistant directly through the third-party communication software, the third-party communication software may be Line, Messenger, WeChat, and the like.

Reference is made to FIG. 5, which is a schematic diagram illustrating an interaction between a user and an intelligent assistant according to an embodiment of the disclosure. As shown in FIG. 5, the user can make a contact with the intelligent assistant through the third-party communication software, the user directly communicates with the intelligent assistant by using the natural language, and the intelligent assistant performs the corresponding operations immediately after the intention of the user is analyzed. For example, in FIG. 5, the user proposes he/she wants to have a travel to Japan from 9/1 to 9/7, after the intention of the user is analyzed by the intelligent assistant as wanting a help with arrangement of a travel schedule for Japan, the intelligent assistant communicates with an intelligent assistant for providing the airline-ticket booking service at the enterprise terminal, so as to help the user with airline-ticket booking according to the dates and place sites provided by the user, and the intelligent assistant also communicates with the intelligent assistant for providing the restaurant reserving service of the enterprise to help the user with restaurant reserving according to the dates and place sites provided by the user. In this embodiment, the user can make a contact with the intelligent assistant for providing the service at the enterprise terminal through the intelligent assistant of himself/herself, which can reduce the time spent by the user greatly. However, of course the embodiments of the disclosure are not limited to this. The user can also directly make a contact with the intelligent assistant for providing the service of the enterprise, which can also achieve the effect of saving time and labor cost.

It can be seen from the aforementioned embodiments of the disclosure, by screening the application program interface files conforming to the service provided by the enterprise to find out the corresponding application program interfaces, the disclosure is mainly capable of quickly building an intelligent assistant, helping the enterprise with providing services to customers in a more convenient and more humanized manner, improving the problem that the consumers have to be familiar with different interfaces provided by different enterprises, thereby achieving the effect of effectively reducing the labor cost and improving the service efficiency.

In addition, although the aforesaid examples include exemplary steps in a sequence, these steps are not necessarily implemented by the shown sequence. Implementing these steps in different orders may be considered within the disclosure content. Within the spirit and scope of embodiments in the disclosure, these steps may be added, replaced, altered in sequence and/or omitted as appropriate.

Although the present invention has been disclosed as aforesaid implementations, the present invention is not limited thereby. Any of those skilled in this art may take various alternations and modifications without departing from the spirit and scope of the present invention. Therefore, the protection ranges of the present invention should be considered subject to those defined by the attached claims.

What is claimed is:

1. A method for automatically building an intelligent assistant, comprising:
acquiring an intelligent assistant template by a processor from a storage device, the intelligent assistant template comprising a plurality of operation functions for accomplishing a service;
acquiring a plurality of application programming interfaces and a plurality of application programming interface files corresponding thereto by the processor;
identifying a plurality of first entities of the plurality of application programming interface files by the processor;
comparing the plurality of first entities of the plurality of application programming interface files to generate a similarity value respectively for each of the plurality of operation functions by the processor;
determining the plurality of application programming interface files and the plurality of application programming interfaces corresponding thereto, respectively corresponding to each of the plurality of operation functions by the processor, according to the similarity value corresponding to the plurality of first entities of the plurality of application programming interface files; and
generating an intelligent assistant according to the determined plurality of application programming interfaces corresponding to the plurality of operation function by the processor.

2. The method for automatically building the intelligent assistant of claim 1, wherein comparing the plurality of first entities of the plurality of application programming interface files to generate the similarity value further comprises:
comparing each first entity of one of the plurality of application programming interface files and the plurality of operation functions of the intelligent assistant template respectively; and
performing a semantic similarity calculation for each entity and the plurality of operation functions to generate the similarity value respectively.

3. The method for automatically building the intelligent assistant of claim 2, wherein the plurality of operation functions of the intelligent assistant template are a plurality of functions required for accomplishing the service sequentially, and the plurality of functions are executed by the plurality of application program interfaces.

4. The method for automatically building the intelligent assistant of claim 2, wherein the semantic similarity calculation performs a semantic similarity analysis according to an attribute field of the plurality of first entities and an attribute field of the plurality of application interface files corresponding to the plurality of operation functions.

5. The method for automatically building the intelligent assistant of claim 1, wherein determining the plurality of application programming interface files and the plurality of application programming interfaces corresponding thereto, respectively corresponding to each of the plurality of operation functions refers to determining an application programming interface file and an application programming interface corresponding thereto with the largest similarity value for each of the plurality of operation functions.

6. The method for automatically building the intelligent assistant of claim 1, wherein intelligent assistant is configured for providing an operation interface, for displaying a result after an application programming interface in the intelligent assistant is transferred to a website to request for performance.

7. The method for automatically building the intelligent assistant of claim 1, wherein the intelligent assistant is configured for providing an operation interface, for inputting natural language data by a user, acquiring the inputting data required by an application program interfaces in the intelligent assistant from the natural language data, and transferring the application program interfaces in the intelligent assistant and the inputting data required by them to the website to request for performance.

8. The method for automatically building the intelligent assistant of claim 1, wherein the method for automatically building the intelligent assistant is automatically building the intelligent assistant corresponding to a specified website, and the plurality of application program interfaces and the plurality of application program interface files corresponding thereto are acquired from the specified website.

9. A system for automatically building an intelligent assistant, comprising:
a processor; and
a storage device, which is electrically connected to the processor and stores an intelligent assistant template, the intelligent assistant template comprising a plurality of operation functions for accomplishing a service;
wherein the processor comprises:
an interpretation module for acquiring a plurality of application programming interfaces and a plurality of application programming interface files corresponding thereto, and identifying a plurality of first entities of the plurality of application programming interface files;
a similarity value calculation module for comparing the plurality of first entities of the plurality of application programming interface files to generate a similarity value respectively for each of the plurality of operation functions;
a service type generation module for determining one of the plurality of application programming interface files and the plurality of application programming interfaces corresponding thereto, respectively corresponding to each of the plurality of operation functions, according to the similarity value corresponding to the plurality of first entities of the plurality of application programming interface files; and
an intelligent assistant building module for generating a intelligent assistant according to the determined plurality of application programming interfaces corresponding to the plurality of operation function.

10. The system for automatically building the intelligent assistant of claim 9, wherein the similarity value calculation module further comprises:
a semantic comparison unit for comparing each first entity of one of the plurality of application programming interface files and the plurality of operation functions of the intelligent assistant template respectively; and
generating a similarity value after performing the semantic similarity calculation.

11. The system for automatically building the intelligent assistant of claim 10, wherein the plurality of operation functions of the intelligent assistant template are the plurality of application programming interface files corresponding thereto as required for accomplishing the service sequentially.

12. The system for automatically building the intelligent assistant of claim 11, wherein the semantic similarity calculation performs a semantic similarity analysis according to an attribute field of the first plurality of entities and an attribute field of the plurality of application interface files corresponding to the plurality of operation functions.

13. The system for automatically building the intelligent assistant of claim 9, wherein determining the plurality of application programming interface files and the plurality of application programming interfaces corresponding thereto, respectively corresponding to each of the plurality of operation functions in the similarity-value calculation module refers to determining an application programming interface file and an application programming interface corresponding thereto with the largest similarity value for each of the plurality of operation functions.

14. The system for automatically building the intelligent assistant of claim 9, wherein intelligent assistant is configured for providing an operation interface, for displaying a displaying result after an application programming interface in the intelligent assistant is transferred to a website to request for performance.

15. The system for automatically building the intelligent assistant of claim 9, wherein the intelligent assistant is configured for providing an operation interface, for inputting natural language data by a user, acquiring the inputting data required by an application program interfaces in the intelligent assistant from the natural language data, and transferring the application program interfaces in the intelligent assistant and the inputting data required by them to the website to request for performance.

16. The system for automatically building the intelligent assistant of claim 9, wherein the system further comprises a template module for automatically building the intelligent assistant is automatically building the intelligent assistant corresponding to a specified website, and the plurality of application program interfaces and the plurality of application program interface files corresponding thereto are acquired from the specified website.
